(19) United States
(12) Patent Application Publication
(10) Pub. No.: US 2023/0305408 A1
(43) Pub. Date: Sep. 28, 2023

(54) BASE MATERIAL FOR ELECTROPHOTOGRAPHIC PHOTORECEPTOR, ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Masaki HIRAKATA, Kanagawa (JP); Kenta IDE, Kanagawa (JP)

(73) Assignee: FUJIFILM Business Innovation Corp., Tokyo (JP)

(21) Appl. No.: 18/177,126

(22) Filed: Mar. 2, 2023

(30) Foreign Application Priority Data
Mar. 28, 2022 (JP) 2022-052250

(51) Int. Cl. G03G 5/10; G03G 15/00

(52) U.S. Cl. CPC G03G 5/102; G03G 15/75

(57) ABSTRACT

A base material for an electrophotographic photoreceptor, in which in a spectrum of a period and an amplitude obtained by performing fast Fourier transform of surface roughness of a 10 mm portion in an axial direction of a surface of the base material for an electrophotographic photoreceptor, an amplitude in a range of a period of 0.4 mm or more and 0.7 mm or less is 0.22 mm or less.

### CROSS-REFERENCE TO RELATED APPLICATIONS

This application is based on and claims priority under 35 USC 119 from Japanese Patent Application No. 2022-052250 filed on Mar. 28, 2022.

### BACKGROUND

### (I) Technical Field

The present invention relates to a base material for an electrophotographic photoreceptor, an electrophotographic photoreceptor, a process cartridge, and an image forming apparatus.

### (II) Related Art

JP 2002-251029 A proposes “A photoreceptor comprising at least a photosensitive layer provided on a substrate, wherein an auto-correlation function C (m·Δt), which is derived by performing discrete Fourier transform on a data group of height x (t) [µm] of a cross-sectional curve obtained by sampling N cross-sectional curves of an interface of the photosensitive layer on the substrate side at intervals of Δt [µm] in a horizontal direction according to a predetermined formula, and further performing discrete inverse Fourier transform of a power spectrum obtained by a predetermined formula, comprises a waveform slowly varying in a large period of about 100 µm and a sharp waveform observed on a peak of the waveform slowly varying in the large period, and an amplitude intensity ratio of an amplitude of the sharp waveform (referred to as a triangular wave) to an amplitude of the waveform slowly varying in the large period is 50% or more”.

JP 2019-061103 A proposes “An image forming apparatus comprising a photoreceptor drum having a surface on which an electrostatic latent image is to be formed and carrying a developer image on the surface; a charging device configured to charge the surface of the photoreceptor drum to a predetermined potential; an exposure device configured to irradiate the surface of the photoreceptor drum charged to the predetermined potential with exposure light according to image data to form the electrostatic latent image; and a developing device having a developing roller that has a circumferential surface carrying a developer and is rotated around a predetermined rotation shaft, and configured to supply the developer to the surface of the photoreceptor drum to develop the electrostatic latent image into the developer image, wherein the exposure device forms the electrostatic latent image with a screen image inclined at a predetermined screen angle θ with respect to a main scanning direction and formed at a predetermined screen ruling X per inch in the main scanning direction, the developing roller has cutting marks extending along a circumferential direction of rotation of the developing roller on the circumferential surface of the developing roller and formed at a predetermined pitch Y along an axial direction of the rotation shaft, and the screen angle θ (degrees), the screen ruling X (lines), and the pitch Y (µm) of the cutting marks satisfy the following relational expression:

$$25.4 / \text{X} \times 0.9 \times cos \text{θ} < \text{Y} \text{or} \text{Y} > 25.4 / \text{X} \times 1.1 \times cos \text{θ} ″ .$$

JP 2014-048242 A proposes “a method for manufacturing a spectacle lens, comprising a preparation step of preparing a lens substrate having surfaces corresponding to an optical surface of a spectacle lens; a cutting step of cutting at least one of the surfaces of the lens substrate to obtain a cut surface; a surface property measurement step of measuring a surface property of the cut surface; a first calculation step of calculating a waviness curve of the cut surface based on a measurement result of the surface property; a second calculation step of calculating parameters relating to amplitudes and wavelengths of the waviness curve from the calculated waviness curve; and an evaluation step of evaluating a quality of the lens substrate using the parameters relating to the amplitudes and the wavelengths”.

### SUMMARY

Aspects of non-limiting embodiments of the present disclosure relate to a base material for an electrophotographic photoreceptor, which suppresses occurrence of vertical streaks (in particular, vertical streaks extending in the circumferential direction of the electrophotographic photoreceptor) in an image to be formed as compared with a case where an amplitude in a range of a period of 0.4 mm or more and 0.7 mm or less exceeds 0.22 mm in a spectrum of a period and an amplitude obtained by performing fast Fourier transform of surface roughness of a 10 mm portion in an axial direction of a surface of the base material for an electrophotographic photoreceptor.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above

According to an aspect of the present disclosure, there is provided a base material for an electrophotographic photoreceptor, wherein in a spectrum of a period and an amplitude obtained by performing fast Fourier transform of surface roughness of a 10 mm portion in an axial direction of a surface of the base material for an electrophotographic photoreceptor, an amplitude in a range of a period of 0.4 mm or more and 0.7 mm or less is 0.22 mm or less.

### BRIEF DESCRIPTION OF THE DRAWINGS

FIG. 1 is a schematic configuration diagram illustrating an example of an image forming apparatus according to an exemplary embodiment.

FIG. 2 is a schematic configuration diagram illustrating another example of the image forming apparatus according to the exemplary embodiment.

### DETAILED DESCRIPTION

Exemplary embodiments, which are examples of the present invention, will now be described. These descriptions and examples exemplify the exemplary embodiments, and do not limit the scope of the invention.

In numerical ranges described stepwise in the present specification, an upper limit value or a lower limit value described in one numerical range may be replaced with an upper limit value or a lower limit value of another numerical range in the stepwise description. In addition, in a numerical range described in the present specification, an upper limit value or a lower limit value of the numerical range may be replaced with a value shown in Examples.

Each component may include a plurality of kinds of the relevant substances.

In a case where the amount of each component in a composition is referred to, and a plurality of kinds of substances corresponding to the component are present in the composition, it means the total amount of the plurality of kinds of substances present in the composition, unless otherwise specified.

In the present disclosure, “to” representing a numerical range represents a range including numerical values described as an upper limit and a lower limit thereof. In addition, in a case where a unit is described only for an upper limit value in a numerical range represented by “to”, it means that the lower limit value also has the same unit.

### Base Material for Electrophotographic Photoreceptor

In the base material for an electrophotographic photoreceptor (hereinafter also simply referred to as “base material for a photoreceptor”) according to an exemplary embodiment, in a spectrum of a period and an amplitude obtained by performing fast Fourier transform of the surface roughness of a 10 mm portion in the axial direction of a surface of the base material for an electrophotographic photoreceptor (hereinafter, the spectrum is also simply referred to as “specific spectrum”), an amplitude in a range of a period of 0.4 mm or more and 0.7 mm or less is 0.22 mm or less.

With the above-described configuration, the base material for a photoreceptor according to the exemplary embodiment suppresses occurrence of vertical streaks in an image to be formed. The reason is presumed as follows.

A conventional base material for a photoreceptor (for example, a base material for a photoreceptor in which an amplitude in a range of a period of 0.4 mm or more and 0.7 mm or less exceeds 0.18 mm in the specific spectrum) may have large unevenness of the surface of the base material in some cases. Therefore, when an electrophotographic photoreceptor (hereinafter also simply referred to as “photoreceptor”) is produced by providing a photosensitive layer on the base material for a photoreceptor, the surface of the photoreceptor may have increased unevenness due to the unevenness of the surface of the base material for a photoreceptor. In this case, when an image is formed, vertical streaks due to the unevenness of the surface of the photoreceptor may occur in the image.

In contrast, the base material for a photoreceptor according to the exemplary embodiment has an amplitude in a range of a period of 0.4 mm or more and 0.7 mm or less of 0.22 mm or less in the specific spectrum. The base material for a photoreceptor having an amplitude of 0.22 mm or less has small surface unevenness. Therefore, when a photoreceptor is produced by providing a photosensitive layer on the base material for a photoreceptor according to the exemplary embodiment, the unevenness of the surface of the photoreceptor due to the unevenness of the surface of the base material for a photoreceptor is also reduced. As a result, when an image is formed, occurrence of vertical streaks in the image due to the unevenness of the surface of the photoreceptor is suppressed.

From the above, it is presumed that the base material for a photoreceptor according to the exemplary embodiment suppresses the occurrence of vertical streaks in an image to be formed.

Examples of a method of setting the amplitude in a range of a period of 0.4 mm or more and 0.7 mm or less in the specific spectrum to 0.22 mm or less include a method of reducing the feed amount and/or a method of increasing the distance between the cutting blade and the base material in the cutting process during the production of the base material for a photoreceptor.

An example of the base material for a photoreceptor according to the exemplary embodiment is described in detail below.

### Amplitude

In the base material for a photoreceptor according to the exemplary embodiment, in a spectrum of a period and an amplitude obtained by performing fast Fourier transform of surface roughness of a 10 mm portion in the axial direction of the surface of the base material for an electrophotographic photoreceptor (that is, a specific spectrum), an amplitude in a range of a period of 0.4 mm or more and 0.7 mm or less is 0.22 mm or less.

The amplitude in the range of the period of 0.4 mm or more and 0.7 mm or less is calculated by observing the surface roughness of a 10 mm portion in the axial direction of the surface of the base material for a photoreceptor, and analyzing the waveform thereof by fast Fourier transform.

Hereinafter, a measurement procedure of the amplitude in the range of the period of 0.4 mm or more and 0.7 mm or less will be specifically described.

First, as for the surface of the base material for a photoreceptor, the surface roughness of the 10 mm potion in the axial direction of the base material for a photoreceptor is measured with a SURFCOM 1400-D (manufactured by TOKYO SEIMITSU CO.,LTD) at a cut-off wavelength of 0.8 mm and a measurement speed of 1.5 mm/s. The measurement may be performed at any position on the surface of the base material for a photoreceptor as long as the measurement is performed in the axial direction of the base material for a photoreceptor.

Two dimensional discrete Fourier transform of the surface roughness is performed by fast Fourier transform (FFT) to obtain a spectrum of periods (mm) and amplitudes (mm) (i.e., the specific spectrum). In the obtained spectrum, the horizontal axis represents a period, the vertical axis represents an amplitude, and the scale of the horizontal axis is indicated by a common logarithm.

It is preferable that the amplitude in the range of the period of 0.4 mm or more and 0.7 mm or less is 0.18 mm or less.

By setting the amplitude in the range of the period of 0.4 mm or more and 0.7 mm or less to be within the above numerical range, the unevenness of the surface of the base material becomes smaller, and when an image is formed, the occurrence of vertical streaks in the image is further suppressed.

In the specific spectrum, it is preferable that the number of amplitude peaks included in the range of the period of 0.4 mm or more and 1.0 mm or less is two or more.

Here, the amplitude peak is a point where the value of the amplitude changes from increase to decrease (that is, an inflection point) in a case where the value of the period is changed in the specific spectrum, and is a point where the value of the amplitude in a period larger than the value of the period of the inflection point by 0.1 mm and the value of the amplitude in a period smaller than the value of the period of the inflection point by 0.1 mm are smaller than the value of the amplitude in the period of the inflection point by 30% or more.

By setting the number of amplitude peaks included in the range of the period of 0.4 mm or more and 1.0 mm or less to two or more, it is possible to further suppress the occurrence of vertical streaks in an image.

The reason why the occurrence of vertical streaks in an image can be further suppressed by setting the number of amplitude peaks to two or more is presumed as follows.

In a case where the photoreceptor is charged, vertical streaks in an image may occur due to film thickness unevenness corresponding to the surface roughness of the base material.

By setting the number of amplitude peaks included in the range of the period of 0.4 mm or more and 1.0 mm or less to two or more, the components of the film thickness unevenness of the photoreceptor are distributed. It is presumed that due to this, occurrence of vertical streaks in the image is further suppressed.

The number of amplitude peaks included in the range of the period of 0.4 mm or more and 1.0 mm or less is preferably two or more and three or less, and more preferably three.

By setting the number of amplitude peaks to the above-described number, the occurrence of vertical streaks in an image can be further suppressed.

The frequency component in the range of the period of 0.4 mm or more and 0.6 mm or less with respect to an entire frequency component in the range of the period of 0.4 mm or more and 1.0 mm or less in the specific spectrum (hereinafter, the rate is also referred to as “specific frequency component rate”) is preferably 30% or more and 50% or less.

By setting the frequency component in the range of the period of 0.4 mm or more and 0.6 mm or less to be within the above numerical range, the frequency component of the film thickness unevenness of the photoreceptor is easily distributed. Accordingly, uneven charging is more easily reduced. Due to this, occurrence of vertical streaks in the image is further suppressed.

From the viewpoint of suppressing vertical streaks in an image, the specific frequency component rate is more preferably 32% or more and 48% or less, and still more preferably 35% or more and 45% or less.

The specific frequency component rate is calculated as follows.

First, the two dimensional discrete Fourier transform of the surface roughness is performed by the fast Fourier transform (FFT) in the same procedure as the measurement procedure of the amplitude in the range of the period of 0.4 mm or more and 0.7 mm or less. An integrated value (µm) of an amplitude (µm) in a range of a period of 0.4 mm or more and 1.0 mm or less is obtained from the FFT calculation result, and this is set as the “frequency component in the range of the period of 0.4 mm or more and 1.0 mm or less”.

Next, an integrated value (µm) of an amplitude (µm) in a range of a period of 0.4 mm or more and 0.6 mm or less is obtained from the FFT calculation result, and this is set as the “frequency component in the range of the period of 0.4 mm or more and 0.6 mm or less”. The integrated value is the sum of the amplitudes (µm) of 1-µm discretized sections.

Then, the percentage of the frequency component in the range of the period of 0.4 mm or more and 0.6 mm or less with respect to the frequency component in the range of the period of 0.4 mm or more and 1.0 mm or less taken as 100 is calculated, and set as the specific frequency component rate.

Examples of the base material for a photoreceptor include a metal (aluminum, copper, zinc, chromium, nickel, molybdenum, vanadium, indium, gold, platinum, and the like); a metal plate containing an alloy (stainless steel and the like); and a metal drum.

Here, the base material for a photoreceptor is preferably conductive. The word “conductive” means that the volume resistivity is less than 10¹³ Ω cm.

### Method for Producing Base Material for Photoreceptor

Hereinafter, an example of a method for producing a base material for a photoreceptor according to an exemplary embodiment will be described, but the method is not limited thereto.

In the method for producing a base material for a photoreceptor according to the exemplary embodiment, first, a raw tube made of a metal, an alloy, or the like is prepared. This raw tube is obtained, for example, by subjecting a metal, an alloy, or the like to hot extrusion processing by a porthole method or a mandrel method and then to cold drawing processing to obtain a raw tube before cutting.

Then, a cutting process is performed on the surface of the raw tube. As the machining tool applied to this cutting process, it is preferable to apply, for example, a machining tool having an arc shape (generally referred to as an R machining tool) or a flat tip (generally referred to as a flat machining tool) made of polycrystalline diamond.

The cutting process is performed, for example, by relatively moving a rotated raw tube and a machining tool pressed against the surface of the raw tube in the axial direction of the raw tube. In the cutting, both rough machining and finish machining may be performed, or only finish machining may be performed. The surface roughness of the base material for a photoreceptor is controlled by finish machining.

Further, in a case where both of the rough machining and the finish machining are performed as the cutting process, the cutting process may be performed by reciprocating one machining tool from one axial end portion to the other axial end portion of the raw tube to perform the rough machining in a forward path and the finish machining in a backward path, but it is preferable that two machining tools are moved from one axial end portion to the other axial end portion of the raw tube to perform the rough machining and the finish machining simultaneously only in the forward path.

In order to obtain a base material for a photoreceptor having an amplitude in a range of a period of 0.4 mm or more and 0.7 mm or less of 0.22 mm or less in the specific spectrum, it is preferable to decrease the tool feed speed or increase the radius R of the tip of the cutting blade.

It is preferable that the tool feed speed (mm/rev (“rev” is revolution)) in the finish machining is, for example, 0.2 mm/rev or more and 0.5 mm/rev or less.

The method for producing a base material for a photoreceptor according to the exemplary embodiment is preferably performed while changing the tool feed speed in the finish machining.

By performing the finish machining while changing the tool feed speed, the number of amplitude peaks included in the range of the period of 0.4 mm or more and 1.0 mm or less in the specific spectrum is likely to be two or more.

An example of a change in the tool feed speed when the machining tool is moved from one axial end portion of the raw tube toward the other axial end portion thereof is as follows.

An example of the tool feed speed at the moving distance (%) of the machining tool with respect to the distance from one axial end portion to the other axial end portion of the raw tube taken as 100 is described below.

### Example 1

The tool feed speed may be arbitrarily reduced and changed between 20% and 50% in a range of the moving distance of the machining tool of 0% to 10%.

The change in the tool feed speed may be a periodic change, or two speed conditions may be mixed.

As a method of controlling the tool feed speed, for example, a method of applying a lathe with numerical control (NC) and performing NC control can be cited.

The base material for a photoreceptor according to the exemplary embodiment is obtained through the above-described steps.

The base material for a photoreceptor may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the acidic treatment liquid, for instance, the amount of the phosphoric acid is in the range of 10% by mass or more and 11% by mass or less, the amount of the chromic acid is in the range of 3% by mass or more and 5% by mass or less, and the amount of the hydrofluoric acid is in the range of 0.5% by mass or more and 2% by mass or less; and the total concentration of these acids is preferably in the range of 13.5% by mass or more and 18% by mass or less. The treatment temperature is, for example, preferably 42° C. or more and 48° C. or less. The film thickness of the coating film is preferably 0.3 µm or more and 15 µm or less.

The boehmite treatment is performed, for example, by immersion in pure water at 90° C. or more and 100° C. or less for 5 minutes to 60 minutes, or by contact with heated steam at 90° C. or more and 120° C. or less for 5 minutes to 60 minutes.

The film thickness of the coating film is preferably 0.1 µm or more and 5 µm or less. The base material for a photoreceptor may be further anodized using an electrolyte solution having low solubility for coating films, such as those of adipic acid, boric acid, borate, phosphate, phthalate, maleate, benzoate, tartrate, or citrate.

### Electrophotographic Photoreceptor

The photoreceptor according to an exemplary embodiment includes a base material for a photoreceptor and a photosensitive layer provided on the base material for a photoreceptor.

Here, the base material for a photoreceptor according to the exemplary embodiment described above is applied as the base material for a photoreceptor.

Layers of the electrophotographic photoreceptor according to the exemplary embodiment will now be described in detail.

### Undercoat Layer

The photoreceptor according to the exemplary embodiment may include an undercoat layer between the base material for a photoreceptor and the photosensitive layer as necessary.

The undercoat layer is, for example, a layer containing inorganic particles and a binder resin.

Examples of the inorganic particles include inorganic particles having a powder resistivity (volume resistivity) that is in the range of 10² Ω · cm or more and 10¹¹ Ω·cm or less.

Among them, as the inorganic particles having the above resistance value, for example, metal oxide particles such as tin oxide particles, titanium oxide particles, zinc oxide particles, and zirconium oxide particles are preferable, and zinc oxide particles are particularly preferable.

The BET specific surface area of the inorganic particles is, for example, preferably 10 m²/g or more.

The volume average particle size of the inorganic particles is, for example, preferably 50 nm or more and 2,000 nm or less (preferably 60 nm or more and 1,000 nm or less).

The content of the inorganic particles is, for example, preferably 10% by mass or more and 80% by mass or less, and more preferably 40% by mass or more and 80% by mass with respect to the amount of the binder resin.

The inorganic particles may be subjected to a surface treatment. Two or more kinds of inorganic particles subjected to different surface treatments or having different particle sizes may be mixed and used.

Examples of a surface treatment agent include a silane coupling agent, a titanate-based coupling agent, an aluminum-based coupling agent, and a surfactant. Silane coupling agents are particularly preferable, and amino-group-containing silane coupling agents are more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more kinds of silane coupling agents may be used as a mixture. For example, an amino-group-containing silane coupling agent and another silane coupling agent may be used in combination. Examples of other silane coupling agents include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using the surface treatment agent may be any known method, and may be a dry method or a wet method.

The amount of the surface treatment agent used in the treatment is preferably 0.5% by mass or more and 10% by mass or less with respect to the amount of the inorganic particles.

Here, the undercoat layer preferably contains an electron-accepting compound (acceptor compound) together with the inorganic particles from the viewpoint of improving long-term stability of electrical characteristics and carrier blocking properties.

Examples of the electron-accepting compound include electron-transporting substances such as quinone-based compounds such as chloranil and bromoanil; tetracyanoquinodimethane-based compounds; fluorenone compounds such as 2,4,7-trinitrofluorenone and 2,4,5,7-tetranitro-9-fluorenone; oxadiazole-based compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone-based compounds; thiophene compounds; and diphenoquinone compounds such as 3,3′,5,5′-tetra-t-butyl diphenoquinone.

In particular, as the electron-accepting compound, a compound having an anthraquinone structure is preferable. As the compound having an anthraquinone structure, for example, a hydroxyanthraquinone compound, an aminoanthraquinone compound, an aminohydroxyanthraquinone compound, and the like are preferable, and specifically, for example, anthraquinone, alizarin, quinizarin, anthrarufin, purpurin, and the like are preferable.

The electron-accepting compound may be dispersed in the undercoat layer together with the inorganic particles, or may be attached to the surface of the inorganic particles.

The electron-accepting compound can be attached to the surfaces of the inorganic particles by, for example, a dry method or a wet method.

According to a dry method, for example, while inorganic particles are being stirred with a mixer having large shear force, an electron-accepting compound as is or dissolved in an organic solvent is added thereto dropwise or sprayed along with dry air or nitrogen gas so that the electron-accepting compound may be attached to the surfaces of the inorganic particles. The dropwise addition or spraying of the electron-accepting compound is preferably performed at a temperature equal to or lower than the boiling point of the solvent. After the dropwise addition or spraying of the electron-accepting compound, baking may be further carried out at 100° C. or more. The baking is not particularly limited as long as it is performed at a temperature and for a period of time at which electrophotographic characteristics are obtained.

The wet method is a method in which the electron-accepting compound is added while the inorganic particles are dispersed in a solvent by, for example, stirring, ultrasonic waves, a sand mill, an attritor, or a ball mill, followed by stirring or dispersing, and then the solvent is removed to attach the electron-accepting compound to the surface of the inorganic particles. Examples of the method for removing the solvent include filtration and distillation. After the removal of the solvent, baking may be further carried out at 100° C. or more. The baking is not particularly limited as long as it is performed at a temperature and for a period of time at which electrophotographic characteristics are obtained. In the wet method, moisture contained in the inorganic particles may be removed before the addition of the electron-accepting compound, and examples thereof include a method of removing moisture while stirring and heating the inorganic particles in a solvent, and a method of removing moisture by azeotropy with a solvent.

Attaching the electron-accepting compound may be performed before, after, or simultaneously with performing the surface treatment on the inorganic particles by using a surface treatment agent.

The content of the electron-accepting compound can be, for example, 0.01% by mass or more and 20% by mass or less, and is preferably 0.01% by mass or more and 10% by mass or less with respect to the amount of the inorganic particles.

Examples of the binder resin used in the undercoat layer include known materials including known polymer compounds such as acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Examples of the binder resin used in the undercoat layer also include a charge-transporting resin having a charge-transporting group and a conductive resin (for example, polyaniline).

Among these, resins insoluble in the coating solvent of the upper layer are preferable as the binder resin used in the undercoat layer, and in particular, thermosetting resins such as urea resins, phenol resins, phenol-formaldehyde resins, melamine resins, urethane resins, unsaturated polyester resins, alkyd resins, and epoxy resins; and resins obtained by reacting at least one resin selected from the group consisting of polyamide resins, polyester resins, polyether resins, methacrylic resins, acrylic resins, polyvinyl alcohol resins, and polyvinyl acetal resins with a curing agent are preferable.

In the case where two or more kinds of such binder resins are used in combination, the mixing ratio is appropriately determined.

The undercoat layer may contain various additives for improving electrical characteristics, environmental stability, and image quality.

Examples of the additives include known materials including electron-transporting pigments, such as condensed polycyclic pigments and azo pigments, and zirconium chelate compounds, titanium chelate compounds, aluminum chelate compounds, titanium alkoxide compounds, organic titanium compounds, and silane coupling agents. A silane coupling agent is used for the surface treatment of the inorganic particles as described above, and may be further added as an additive to the undercoat layer.

Examples of the silane coupling agent as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanolaminate, and polyhydroxytitanium stearate.

Examples of the aluminum chelate compound include aluminum isopropylate, monobutoxy aluminum diisopropylate, aluminum butyrate, diethyl acetoacetate aluminum diisopropylate, and aluminum tris(ethyl acetoacetate).

These additives may be used singly, or as a mixture or a polycondensate of a plurality of compounds.

The undercoat layer preferably has a Vickers hardness of not less than 35.

The undercoat layer preferably has a surface roughness (ten point average roughness) adjusted in the range of 1/(4n) (where “n” represents the index of refraction of the upper layer) to ½ of the wavelength λ of the laser light used for exposure in order to reduce Moire fringes.

In order to adjust the surface roughness, for example, resin particles may be added to the undercoat layer. Examples of the resin particles include silicone resin particles and crosslinked polymethylmethacrylate resin particles. Furthermore, the surface of the undercoat layer may be polished to adjust the surface roughness. Examples of a polishing technique include buff polishing, sand blasting, wet honing, and grinding.

The formation of the undercoat layer is not particularly limited, and a well-known formation method is used. For example, the formation is performed by forming a coating film of an undercoat layer-forming coating liquid obtained by adding the above-described components to a solvent, drying the coating film, and heating the coating film as necessary.

Examples of the solvent for preparing the undercoat layer-forming coating liquid include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of a technique for dispersing the inorganic particles in the preparation of the undercoat layer-forming coating liquid include known techniques which involve using a roll mill, a ball mill, a vibrating ball mill, an attritor, a sand mill, a colloid mill, or a paint shaker.

Examples of a method for applying the undercoat layer-forming coating liquid to the base material for a photoreceptor include common methods such as blade coating, wire-bar coating, spray coating, dip coating, bead coating, air knife coating, and curtain coating.

The film thickness of the undercoat layer is, for example, preferably set in the range of 15 µm or more, and more preferably set in the range of 20 µm or more and 50 µm or less.

### Intermediate Layer

An intermediate layer (not illustrated) may be additionally formed between the undercoat layer and the photosensitive layer.

An example of the intermediate layer is a layer containing a resin. Examples of the resin used for the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organometallic compound. Examples of such an organometallic compound used in the intermediate layer include organometallic compounds containing a metal atom such as a zirconium atom, a titanium atom, an aluminum atom, a manganese atom, or a silicon atom.

The compounds used in the intermediate layer may be used singly, or as a mixture or a polycondensate of a plurality of compounds.

Among these, the intermediate layer is preferably a layer containing an organometallic compound containing a zirconium atom or a silicon atom.

The formation of the intermediate layer is not particularly limited, and a well-known formation method is used. For example, the formation is performed by forming a coating film of an intermediate layer-forming coating liquid obtained by adding the above-described components to a solvent, drying the coating film, and heating the coating film as necessary.

Examples of a coating method for forming the intermediate layer include common methods such as dip coating, push-up coating, wire-bar coating, spray coating, blade coating, knife coating, and curtain coating.

The film thickness of the intermediate layer is, for example, preferably set in a range of 0.1 µm or more and 3 µm or less. The intermediate layer may also serve as an undercoat layer.

### Charge Generating Layer

The charge generating layer is, for example, a layer containing a charge generating material and a binder resin. The charge generating layer may be a vapor-deposited layer of a charge generating material. The vapor-deposited layer of the charge generating material is suitable for a case where an incoherent light source such as a light emitting diode (LED) or an organic electro-luminescence (EL) image array is used.

Examples of the charge generating material include azo pigments such as bisazo and trisazo; fused aromatic pigments such as dibromoanthanthrone; perylene pigments; pyrrolopyrrole pigments; phthalocyanine pigments; zinc oxide; and trigonal selenium.

Among these, a metal phthalocyanine pigment or a metal-free phthalocyanine pigment is preferably used as the charge generating material in order to correspond to laser exposure in a near infrared region. Specifically, for example, hydroxygallium phthalocyanine; chlorogallium phthalocyanine; dichlorotin phthalocyanine; and titanyl phthalocyanine are more preferable.

On the other hand, in order to correspond to laser exposure in the near-ultraviolet region, as the charge generating material, a fused aromatic pigment such as dibromoanthanthrone; a thioindigo pigment; a porphyrazine compound; zinc oxide; trigonal selenium; a bisazo pigment, and the like are preferable.

When an incoherent light source such as a light emitting diode (LED) or an organic electro-luminescence (EL) image array having an emission center wavelength in the range of 450 nm or more and 780 nm or less is used, the above-described charge generating material may also be used; however, from the viewpoint of resolution, when the photosensitive layer is used in the form of a thin film having a thickness of 20 µm or less, the electric field strength in the photosensitive layer increases, and deterioration of charge due to charge injection from the base material for a photoreceptor, that is, an image defect called a black spot is likely to occur. This phenomenon is significant when a charge generating material that is a p-type semiconductor and easily generates dark current, such as trigonal selenium or a phthalocyanine pigment, is used.

In contrast, when an n-type semiconductor such as a fused aromatic pigment, a perylene pigment, or an azo pigment is used as the charge generating material, dark current rarely occurs and fewer image defects called black spots occur despite a small thickness.

Whether the semiconductor is of n-type or not is determined by a typical time-of-flight method in which the polarity of photoelectric current flowing therein is determined and a compound that allows electrons rather than holes to flow as a carrier is determined to be of the n-type.

The binder resin used in the charge generating layer is selected from a wide range of insulating resins, and the binder resin may also be selected from organic photoconductive polymers such as poly-N-vinylcarbazole, polyvinylanthracene, polyvinylpyrene, and polysilane.

Examples of the binder resin include polyvinyl butyral resins, polyarylate resins (e.g., polycondensates of bisphenols and aromatic dicarboxylic acids), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. Herein, “insulating” means that the volume resistivity is 10¹³ Ω cm or more.

These binder resins are used singly or as a mixture of two or more kinds.

The mixing ratio of the charge generating material to the binder resin is preferably in the range of 10 : 1 to 1 : 10 by mass.

The charge generating layer may further contain other well-known additives.

The formation of the charge generating layer is not particularly limited, and a well-known formation method is used. For example, the formation is performed by forming a coating film of a charge generating layer-forming coating liquid obtained by adding the above-described components to a solvent, drying the coating film, and heating the coating film as necessary. The charge generating layer may be formed by vapor deposition of a charge generating material. The formation of the charge generating layer by vapor deposition is suitable particularly when a fused aromatic pigment or a perylene pigment is used as the charge generating material.

Examples of the solvent for preparing the charge generating layer-forming coating liquid include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used singly or as a mixture of two or more kinds thereof.

Examples of a method for dispersing particles (for example, a charge generating material) in the charge generating layer-forming coating liquid include media dispersing machines such as a ball mill, a vibrating ball mill, an attritor, a sand mill, and a horizontal sand mill, and medialess dispersing machines such as a stirrer, an ultrasonic dispersing machine, a roll mill, and a high-pressure homogenizer. Examples of the high-pressure homogenizer include a homogenizer of a collision method in which dispersion is performed by liquid-liquid collision or liquid-wall collision of a dispersion liquid in a high-pressure state, and a homogenizer of a penetration method in which dispersion is performed by penetration through a fine flow path in a high-pressure state.

In conducting dispersion, it is effective to control the average particle size of the charge generating material in the charge generating layer-forming coating liquid to 0.5 µm or less, preferably to 0.3 µm or less, and more preferably to 0.15 µm or less.

Examples of a method for applying the charge generating layer-forming coating liquid to the undercoat layer (or the intermediate layer) include common methods such as blade coating, wire-bar coating, spray coating, dip coating, bead coating, air knife coating, and curtain coating.

The film thickness of the charge generating layer is, for example, preferably set in the range of 0.1 µm or more and 5.0 µm or less, and more preferably set in the range of 0.2 µm or more and 2.0 µm or less.

### Charge Transport Layer

The charge transport layer is, for example, a layer containing a charge transport material and a binder resin. The charge transport layer may be a layer containing a polymer charge transport material.

Examples of the charge transport material include electron-transporting compounds such as quinone-based compounds such as p-benzoquinone, chloranil, bromanil, and anthraquinone; tetracyanoquinodimethane-based compounds; fluorenone compounds such as 2,4,7-trinitrofluorenone; xanthone-based compounds; benzophenone-based compounds; cyanovinyl-based compounds; and ethylene-based compounds. Examples of the charge transport material also include hole-transporting compounds such as triarylamine-based compounds, benzidine-based compounds, aryl alkane-based compounds, aryl-substituted ethylene-based compounds, stilbene-based compounds, anthracene-based compounds, and hydrazone-based compounds. These charge transport materials may be used singly or in combination of two or more kinds thereof, but are not limited thereto.

As the charge transport material, a triarylamine derivative represented by the following structural formula (a-1) and a benzidine derivative represented by the following structural formula (a-2) are preferable from the viewpoint of charge mobility.

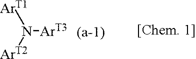

In the structural formula (a-1), Ar^{T1}, Ar^{T2}, and Ar^{T3} each independently represent a substituted or unsubstituted aryl group, -C₆H₄-C(R^{T4})=C(R^{T5})(R^{T6}), or -C₆H₄-CH=CH-CH=C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituents of the groups described above include a halogen atom, an alkyl group having 1 or more and 5 or less carbon atoms, and an alkoxy group having 1 or more and 5 or less carbon atoms. In addition, examples of the substituents of the groups described above

also include a substituted amino group substituted with an alkyl group having 1 or more and 3 or less carbon atoms.

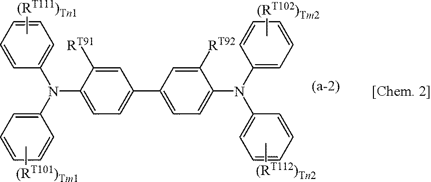

In the structural formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, -C(R^{T12})=C(R^{T13})(R^{T14}), or -CH=CH-CH=C(R^{T15})(R^{T6}), and R^{T12}, R^{T13}, R^{T14}, R^{T15} and R^{T16} each independently represent a hydrogen atom, a substituted or unsubstituted alkyl group, or a substituted or unsubstituted aryl group. Tm1, Tm2, Tn1, and Tn2 each independently represent an integer of 0 to 2.

Examples of the substituents of the groups described above include a halogen atom, an alkyl group having 1 or more and 5 or less carbon atoms, and an alkoxy group having 1 or more and 5 or less carbon atoms. In addition, examples of the substituents of the groups described above also include a substituted amino group substituted with an alkyl group having 1 or more and 3 or less carbon atoms.

Here, of the triarylamine derivative represented by the structural formula (a-1) and the benzidine derivative represented by the structural formula (a-2), a triarylamine derivative having “-C₆H₄-CH=CH-CH=C(R^{T7})(R^{T8})” and a benzidine derivative having “-CH=CH-CH=C(R^{T15})(R^{T16})” are particularly preferable from the viewpoint of charge mobility.

As the polymer charge transport material, known materials having a charge transport property such as poly-N-vinylcarbazole and polysilane are used. Polyester-based polymer charge transport materials are particularly preferable. The polymer charge transport material may be used singly or in combination with a binder resin.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrenebutadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilane. Among these, a polycarbonate resin or a polyarylate resin is suitable as the binder resin. These binder resins are used singly or in combination of two or more kinds thereof.

The mixing ratio of the charge transport material to the binder resin is preferably 10 : 1 to 1 : 5 by mass.

The charge transport layer may contain other well-known additives.

The formation of the charge transport layer is not particularly limited, and a well-known formation method is used. For example, the formation is performed by forming a coating film of a charge transport layer-forming coating liquid obtained by adding the above-described components to a solvent, drying the coating film, and heating the coating film as necessary.

Examples of the solvent used for preparing the charge transport layer-forming coating liquid include common organic solvents such as aromatic hydrocarbons (e.g., benzene, toluene, xylene, and chlorobenzene); ketones (e.g., acetone and 2-butanone); halogenated aliphatic hydrocarbons (e.g., methylene chloride, chloroform, and ethylene chloride); and cyclic or linear ethers (e.g., tetrahydrofuran and ethyl ether). These solvents are used singly or as a mixture of two or more kinds thereof.

Examples of the coating method for applying the charge transport layer-forming coating liquid to the charge generating layer include common methods such as blade coating, wire-bar coating, spray coating, dip coating, bead coating, air knife coating, and curtain coating.

The film thickness of the charge transport layer is, for example, preferably set in the range of 5 µm or more and 50 µm or less, and more preferably set in the range of 10 µm or more and 30 µm or less.

### Protective Layer

The protective layer is provided on the photosensitive layer as necessary. The protective layer is provided, for example, for the purpose of preventing a chemical change of the photosensitive layer at the time of charging or further improving the mechanical strength of the photosensitive layer.

Therefore, a layer formed of a cured film (crosslinked film) is preferably applied as the protective layer. Examples of these layers include layers shown in the following 1) or 2).
1) A layer formed of a cured film of a composition containing a reactive group-containing charge transport material having a reactive group and a charge-transporting skeleton in the same molecule (that is, a layer containing a polymer or a crosslinked product of the reactive group-containing charge transport material).
2) A layer formed of a cured film of a composition containing a non-reactive charge transport material and a reactive group-containing non-charge transport material having a reactive group but not having a charge-transporting skeleton (that is, a layer containing a non-reactive charge transport material and a polymer or a crosslinked product of the reactive group-containing non-charge transport material).

Examples of the reactive group of the reactive group-containing charge transport material include well-known reactive groups such as chain polymerizable groups, epoxy groups, —OH, -OR (wherein R represents an alkyl group), —NH₂, —SH, —COOH, and -SiR^{Q1}_{3-Qn}(OR^{Q2})_{Qn} (wherein R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3).

The chain polymerizable group is not particularly limited as long as it is a functional group capable of radical polymerization, and is, for example, a functional group having a group containing at least a carbon double bond. Specific examples thereof include a group containing at least one selected from a vinyl group, a vinyl ether group, a vinyl thioether group, a styryl group (vinyl phenyl group), an acryloyl group, a methacryloyl group, and derivatives thereof. Among these, a group containing at least one selected from a vinyl group, a styryl group (vinyl phenyl group), an acryloyl group, a methacryloyl group, and derivatives thereof is preferable as the chain polymerizable group because of excellent reactivity.

The charge-transporting skeleton of the reactive group-containing charge transport material is not particularly limited as long as it has a known structure in an electrophotographic photoreceptor, and examples thereof include a structure which is derived from a nitrogen-containing hole-transporting compound such as a triarylamine-based compound, a benzidine-based compound, or a hydrazone-based compound and is conjugated with a nitrogen atom. Among them, a triarylamine skeleton is preferable.

The reactive group-containing charge transport material having a reactive group and a charge-transporting skeleton, the non-reactive charge transport material, and the reactive group-containing non-charge transport material may be selected from well-known materials.

The protective layer may contain other well-known additives.

The formation of the protective layer is not particularly limited, and a well-known formation method is used. For example, the formation is performed by forming a coating film of a protective layer-forming coating liquid obtained by adding the above-described components to a solvent, drying the coating film, and curing the coating film by heating as necessary.

Examples of the solvent for preparing the protective layer-forming coating liquid include aromatic solvents such as toluene and xylene; ketone-based solvents such as methyl ethyl ketone, methyl isobutyl ketone, and cyclohexanone; ester-based solvents such as ethyl acetate and butyl acetate; ether-based solvents such as tetrahydrofuran and dioxane; cellosolve-based solvents such as ethylene glycol monomethyl ether; and alcohol-based solvents such as isopropyl alcohol and butanol. These solvents are used singly or as a mixture of two or more kinds thereof.

The protective layer-forming coating liquid may be a solventless coating liquid.

Examples of a method for applying the protective layer-forming coating liquid to the photosensitive layer (for example, the charge transport layer) include common methods such as dip coating, push-up coating, wire-bar coating, spray coating, blade coating, knife coating, and curtain coating.

The film thickness of the protective layer is, for example, preferably set in the range of 1 µm or more and 20 µm or less, and more preferably set in the range of 2 µm or more and 10 µm or less.

### Single-Layer Type Photosensitive Layer

The single-layer type photosensitive layer (charge generating/charge transport layer) is a layer containing, for example, a charge generating material and a charge transport material, and optionally a binder resin and other well-known additives. These materials are the same as the materials described for the charge generating layer and the charge transport layer.

In addition, in the single-layer type photosensitive layer, the content of the charge generating material may be 0.1% by mass or more and 10% by mass or less, and is preferably 0.8% by mass or more and 5% by mass or less with respect to the total solid content. In addition, the content of the charge transport material in the single-layer type photosensitive layer is preferably 5% by mass or more and 50% by mass or less with respect to the total solid content.

The method for forming the single-layer type photosensitive layer is the same as the method for forming the charge generating layer or the charge transport layer.

The film thickness of the single-layer type photosensitive layer may be, for example, 5 µm or more and 50 µm or less, and is preferably 10 µm or more and 40 µm or less.

[Image forming apparatus (and process cartridge)] An image forming apparatus of an exemplary embodiment includes an electrophotographic photoreceptor; a charging unit that charges a surface of the electrophotographic photoreceptor; an electrostatic latent image forming unit that forms an electrostatic latent image on the charged surface of the electrophotographic photoreceptor; a developing unit that forms a toner image by developing the electrostatic latent image formed on the surface of the electrophotographic photoreceptor with a developer containing a toner; and a transfer unit that transfers the toner image onto a surface of a recording medium. The electrophotographic photoreceptor according to the exemplary embodiment is applied as the electrophotographic photoreceptor.

Examples of the image forming apparatus according to the exemplary embodiment include well-known image forming apparatuses such as an apparatus including a fixing unit that fixes a toner image transferred to a surface of a recording medium; an apparatus employing a direct transfer method in which a toner image formed on a surface of an electrophotographic photoreceptor is directly transferred to a recording medium; an apparatus employing an intermediate transfer method in which a toner image formed on a surface of an electrophotographic photoreceptor is primarily transferred to a surface of an intermediate transfer member and the toner image transferred to the surface of the intermediate transfer member is secondarily transferred to a surface of a recording medium; an apparatus including a cleaning unit that cleans the surface of an electrophotographic photoreceptor before charging after the transfer of a toner image; an apparatus including a charge eliminating unit that eliminates charges by irradiating the surface of the electrophotographic photoreceptor with charge eliminating light before charging after the transfer of a toner image; and an apparatus including an electrophotographic photoreceptor heating member that decreases the relative temperature by increasing the temperature of the electrophotographic photoreceptor.

In the case of an intermediate transfer type apparatus, the transfer unit includes, for example, an intermediate transfer member onto the surface of which a toner image is transferred, a primary transfer unit that primarily transfers the toner image formed on the surface of the electrophotographic photoreceptor onto the surface of the intermediate transfer member, and a secondary transfer unit that secondarily transfers the toner image transferred onto the surface of the intermediate transfer member onto the surface of a recording medium.

The image forming apparatus according to the exemplary embodiment may be either a dry development type image forming apparatus or a wet development type (a development type in which a liquid developer is used) image forming apparatus.

In the image forming apparatus according to the exemplary embodiment, for example, a portion including the electrophotographic photoreceptor may have a cartridge structure (process cartridge) that is detachably attachable to the image forming apparatus. As the process cartridge, for example, a process cartridge including the electrophotographic photoreceptor according to the exemplary embodiment is suitably used. In addition to the electrophotographic photoreceptor, the process cartridge may include, for example, at least one selected from the group consisting of a charging unit, an electrostatic latent image forming unit, a developing unit, and a transfer unit.

Examples of the image forming apparatus according to the exemplary embodiment are shown below, but the image forming apparatus is not limited thereto. Main parts shown in the drawings will be described, and the description of other parts will be omitted.

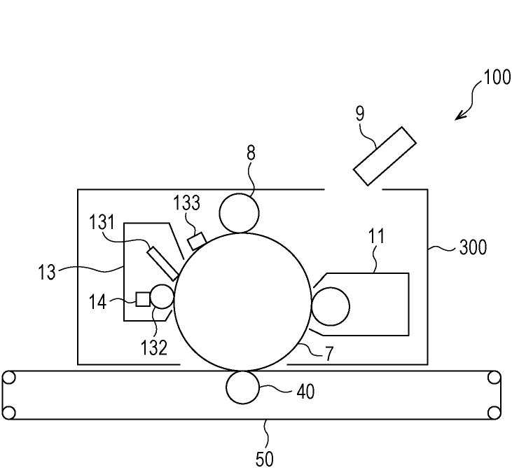

FIG. 1 is a schematic configuration diagram illustrating an example of the image forming apparatus according to the exemplary embodiment.

As illustrated in FIG. 1, an image forming apparatus 100 according to the exemplary embodiment includes a process cartridge 300 including an electrophotographic photoreceptor 7, an exposure device 9 (an example of an electrostatic latent image forming unit), a transfer device 40 (a primary transfer device), and an intermediate transfer member 50. In the image forming apparatus 100, the exposure device 9 is placed at a position where the electrophotographic photoreceptor 7 may be exposed through an opening of the process cartridge 300 for exposure, the transfer device 40 is disposed at a position opposed to the electrophotographic photoreceptor 7 with the intermediate transfer member 50 interposed therebetween, and the intermediate transfer member 50 is disposed in a state in which part thereof is in contact with the electrophotographic photoreceptor 7. Although not illustrated in the drawing, a secondary transfer device that transfers the toner image on the intermediate transfer member 50 onto a recording medium (for example, a paper sheet) is also provided to the image forming apparatus 100. The intermediate transfer member 50, the transfer device 40 (primary transfer device), and the secondary transfer device (not illustrated) correspond to an example of a transfer unit.

The process cartridge 300 in FIG. 1 integrally supports the electrophotographic photoreceptor 7, a charging device 8 (an example of a charging unit), a developing device 11 (an example of a developing unit), and a cleaning device 13 (an example of a cleaning unit) in a housing. The cleaning device 13 includes a cleaning blade (an example of a cleaning member) 131, and the cleaning blade 131 is disposed so as to be in contact with the surface of the electrophotographic photoreceptor 7. The cleaning member is not limited to the form of the cleaning blade 131, and may be a conductive or insulating fibrous member, which may be used singly or in combination with the cleaning blade 131.

FIG. 1 shows an example of the image forming apparatus provided with a fibrous member 132 (in a roll shape) for supplying a lubricant 14 to the surface of the electrophotographic photoreceptor 7 and a fibrous member 133 (in a flat brush shape) for assisting cleaning, but these are disposed as necessary.

Components of the image forming apparatus according to the exemplary embodiment will now be described.

### Charging Device

As the charging device 8, for example, a contact-type charger including a conductive or semiconductive charging roller, charging brush, charging film, charging rubber blade, charging tube, or the like is used. Known chargers can be also used, such as a noncontact-type roller charger or a scorotron or corotron charger utilizing corona discharge.

### Exposure Device

Example of the exposure device 9 include an optical system device that exposes in a predetermined image pattern the surface of the electrophotographic photoreceptor 7 to a light such as a semiconductor laser, an LED, or a liquid crystal shutter light. The wavelength of the light source is within the spectral sensitivity region of the electrophotographic photoreceptor. As a wavelength of the semiconductor laser, near infrared having an oscillation wavelength near 780 nm is mainstream. The wavelength is not limited thereto, and laser light having an oscillation wavelength of 600 nm level, and as blue laser light, laser light having an oscillation wavelength of 400 nm or more and 450 nm or less can also be used. In order to form a color image, a surface-emitting laser light source capable of outputting multiple beams is also effective.

### Developing Device

Examples of the developing device 11 include a general developing device that develops an image by bringing a developer into contact with the developing device or without bringing the developer into contact with the developing device. The developing device 11 is not particularly limited as long as it has such a function, and a proper structure is selected on the basis of the intended purpose. An example thereof is a known developing device that has a function of causing a one component or two component developer to attach to the electrophotographic photoreceptor 7 by using a brush, a roller, or the like. In particular, a developing device including a developing roller which holds a developer on its surface is preferable.

The developer used in the developing device 11 may be a one component developer containing only a toner or a two component developer containing a toner and a carrier. In addition, the developer may be magnetic or non-magnetic. Well-known developers can be used as such developers.

### Cleaning Device

The cleaning device 13 is a cleaning blade device including the cleaning blade 131.

In addition to the cleaning blade system, a fur brush cleaning system or a simultaneous development and cleaning system may be employed.

### Transfer Device

An example of the transfer device 40 is a known transfer charger including a contact-type transfer charger that uses a belt, a roller, a film, or a rubber blade, and a scorotron transfer charger or a corotron transfer charger that utilizes corona discharge.

### Intermediate Transfer Member

As the intermediate transfer member 50, a belt-shaped member (intermediate transfer belt) containing polyimide, polyamideimide, polycarbonate, polyarylate, polyester, rubber, or the like to which semiconductivity is imparted is used. As the form of the intermediate transfer member, a drum-shaped intermediate transfer member may be used instead of a belt-shaped intermediate transfer member.

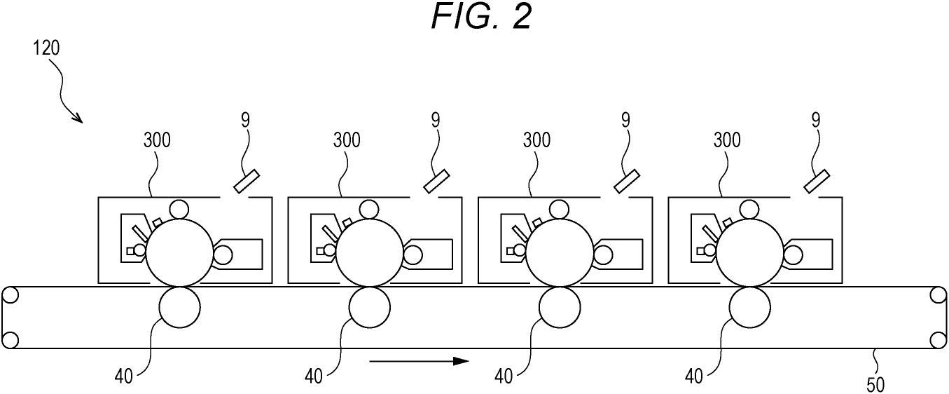

FIG. 2 is a schematic configuration diagram illustrating another example of the image forming apparatus according to the exemplary embodiment.

An image forming apparatus 120 illustrated in FIG. 2 is a multi-color image forming apparatus of a tandem-type equipped with four process cartridges 300. In the image forming apparatus 120, the four process cartridges 300 are respectively arranged in parallel on an intermediate transfer member 50, and one electrophotographic photoreceptor is provided for one color. The image forming apparatus 120 has the same configuration as that of the image forming apparatus 100, except that it is of a tandem-type.

### EXAMPLES

Hereinafter, examples will be described, but the present invention is not limited to these examples. In the following description, “parts” and “%” are all on a mass basis unless otherwise specified.

### Examples 1, 2, and 3

A tube shape is formed by hot extrusion processing according to the port hole method, A6063TD defined in JIS H4080, and this is subjected to cold drawing processing to adjust the accuracy to obtain H14, thereby obtaining a raw tube for cutting (material: aluminum). The outer diameter is φ30.3 mm, the internal diameter is φ27.6 mm, and the total length is 406 mm.

The outside of the raw tube is held, and both ends are subjected to spigot working. The internal diameter of the raw tube subjected to spigot working is φ28.5 mm, and the depth thereof is 10 mm. Both ends are processed at the same time, and the total length of the raw tube is 404 mm.

The raw tube having been subjected to spigot working is subjected to an outer diameter cutting process by a photosensitive drum outer diameter finishing CNC lathe RL-550EX (outer diameter finishing machine using a diamond machining tool for the outer diameter of a photosensitive drum in a copying machine, a laser printer, or the like, manufactured by EGURO LTD.). The machining tool is an arc-shaped machining tool having polycrystalline diamond as a cutting edge and having a tip R of 10 mm.

The outer diameter cutting conditions are set as follows.

One hundred pieces are continuously cut at a tool feed speed of 0.5 mm/rev and measured, and base materials corresponding to Examples 1, 2, and 3 are selected and obtained.

### Example 4

A base material for a photoreceptor is obtained in the same manner as in Example 1 except that the outer diameter cutting conditions are changed as follows.

The cutting is performed under a condition in which the tool feed speed is changed between 0.45 mm/rev and 0.55 mm/rev every 2 seconds to obtain a base material.

### Example 5

A base material for a photoreceptor is obtained in the same manner as in Example 1 except that the outer diameter cutting conditions are changed as follows.

The cutting is performed under a condition in which the tool feed speed is changed between 0.45 mm/rev, 0.50 mm/rev, and 0.60 mm/rev in this order every 1.5 seconds to obtain a base material.

### Example 6

A base material for a photoreceptor is obtained in the same manner as in Example 1 except that the outer diameter cutting conditions are changed as follows.

The cutting is performed under a condition in which tool feed speeds of 0.45 mm/rev for 1.5 seconds and 0.6 mm/rev for 1 second are alternately repeated to obtain a base material.

### Example 7

A base material for a photoreceptor is obtained in the same manner as in Example 1 except that the outer diameter cutting conditions are changed as follows.

The cutting is performed under a condition in which tool feed speeds of 0.50 mm/rev for 1.5 seconds and 0.65 mm/rev for 1 second are alternately repeated to obtain a base material.

### Example 8

A base material for a photoreceptor is obtained in the same manner as in Example 1 except that the outer diameter cutting conditions are changed as follows.

The cutting is performed under a condition in which the tool feed speed is changed between 0.40 mm/rev, 0.48 mm/rev, and 0.60 mm/rev in this order every 1.5 seconds to obtain a base material.

### Example 9

A base material for a photoreceptor is obtained in the same manner as in Example 1 except that the outer diameter cutting conditions are changed as follows.

The cutting is performed under a condition in which the tool feed speed is changed between 0.45 mm/rev and 0.6 mm/rev in this order every 1 second to obtain a base material.

### Comparative Example 1

A base material for a photoreceptor is obtained in the same manner as in Example 1 except that the outer diameter cutting conditions are changed as follows.

One hundred pieces are continuously cut at a tool feed speed of 0.65 mm/rev and measured, and a base material corresponding to Comparative Example 1 is selected.

### Evaluation

First, an electrophotographic photoreceptor is produced according to the following procedure using the base material for a photoreceptor produced in each of the examples.

### Production of Electrophotographic Photoreceptor

Surface treatment examples for use in the undercoat layer are prepared as follows. In a stainless steel bat, 100 parts by mass of zinc oxide particles (trade name: Nano Tek ZnO, manufactured by C. I. Kasei Co., Ltd.) are heated at 120° C. for 2 hours and preliminarily dried. The preliminarily dried zinc oxide is sprayed with 40 parts by mass of a 4% by mass toluene solution of N-β(aminoethyl)-γ-aminopropyltrimethoxysilane (silane coupling agent) while being stirred, and the mixture is stirred at 100° C. for 1 hour. Thereafter, a baking treatment is further performed at 175° C. for 1 hour, and then a pulverization treatment is performed using a mortar.

Next, 25 parts by mass of the obtained zinc oxide surface-treated with the surface treatment example, 10 parts by mass of a curing agent (blocked isocyanate SUMIDUR 3175, manufactured by Sumitomo Bayer Urethane Co., Ltd.), 9 parts by mass of a butyral resin S-LEC BM-1 (manufactured by Sekisui Chemical Co., Ltd.), and 60 parts by mass of methyl ethyl ketone are mixed and dispersed for 2 hours with a sand mill using glass beads having a diameter of 1 mm φ, and as a result, a dispersion liquid is obtained.

Next, 3 parts by mass of silicone balls TOSPEARL 120 (manufactured by Toshiba Silicone Co., Ltd.) and 0.01 parts by mass of silicone oil SH29PA (manufactured by Toray Dow Corning Silicone Co., Ltd.) are added to the resulting dispersion liquid to obtain an undercoat layer coating liquid.

This coating liquid is applied onto a base material for a photoreceptor by dip coating, and is dried and cured at 160° C. for 60 minutes to form an undercoat layer having a layer thickness of 25 µm.

Next, a photosensitive layer having a layer structure is formed on the undercoat layer. A mixture containing 15 parts by mass of gallium phthalocyanine chloride (charge generating material) having diffraction peaks at Bragg angles (2θ ± 0.2°) of at least 7.4°, 16.6°, 25.5°, and 28.3° in an X-ray diffraction spectrum obtained by using CuKα ray, 10 parts by mass of a vinyl chloride-vinyl acetate copolymer resin (binder resin) (VMCH, manufactured by Nippon Unicar Company Limited), and 300 parts by mass of n-butyl acetate is dispersed using glass beads having a diameter of 1 mm φ with a sand mill for 4 hours.

The undercoat layer is dip-coated with the obtained dispersion liquid as a charge generating layer-forming coating liquid, and the dispersion liquid is dried to form a charge generating layer having a layer thickness of 0.2 µm.

Further, 4 parts by mass of N,N′-diphenyl-N,N′-bis(3-methylphenyl)-[1,1′]biphenyl-4,4′-diamine and 6 parts by mass of a bisphenol Z polycarbonate resin (viscosity-average molecular weight: 40,000) are added to 80 parts by mass of chlorobenzene and dissolved therein.

The charge generating layer is dip-coated with the obtained dispersion liquid as a charge transport layer-forming coating liquid, and the dispersion liquid is dried at 130° C. for 40 minutes to form a charge transport layer having a layer thickness of 25 µm.

### Evaluation

The obtained electrophotographic photoreceptor is incorporated into a process cartridge and attached to an image forming apparatus DocuCentre-III C4400 (manufactured by FUJIFILM Business Innovation Japan Corp.). A halftone image having a density of 30% is output, and the degree of occurrence of vertical streaks (streaks in the circumferential direction of the electrophotographic photoreceptor) in the image is visually evaluated.
G1: No vertical streaks are visually observed
G2: Slight vertical streaks are visually observed but there is no problem
G3: Vertical streaks are visually observed but there is no problem
G4: Clear vertical streaks are visually observed, which causes a problem

TABLE 1

| | Maximum value of amplitude (mm) for period of 0.4 to 0.7 mm | Number of peaks in period of 0.4 to 1.0 mm | Specific frequency component rate (%) | Evaluation |
|---|---|---|---|---|
| Example 1 | 0.15 | 1 | 100 | G2 |
| Example 2 | 0.22 | 1 | 100 | G3 |
| Example 3 | 0.18 | 1 | 100 | G2 |
| Example 4 | 0.22 | 2 | 50 | G2 |
| Example 5 | 0.13 | 3 | 55 | G1 |
| Example 6 | 0.15 | 2 | 30 | G2 |
| Example 7 | 0.17 | 2 | 55 | G3 |
| Example 8 | 0.11 | 3 | 45 | G1 |
| Example 9 | 0.16 | 2 | 46 | G2 |
| Comparative Example 1 | 0.25 | 1 | 100 | G4 |

The details of abbreviations in Table 1 are described below.
Maximum value of amplitude (mm) for period of 0.4 to 0.7 mm: maximum value of amplitude in a range of a period of 0.4 mm or more and 0.7 mm or less in the specific spectrum.
Number of peaks in period of 0.4 to 1.0 mm: number of amplitude peaks included in a range of a period of 0.4 mm or more and 1.0 mm or less in the specific spectrum.
Specific frequency component rate (%): frequency component in a range of a period of 0.4 mm or more and 0.6 mm or less with respect to an entire frequency component in the range of the period of 0.4 mm or more and 1.0 mm or less in the specific spectrum.

From the above results, it is understood that the base materials for a photoreceptor of examples of the present invention suppress the occurrence of vertical streaks in an image to be formed.

What is claimed is:

1. A base material for an electrophotographic photoreceptor, wherein in a spectrum of a period and an amplitude obtained by performing fast Fourier transform of surface roughness of a 10 mm portion in an axial direction of a surface of the base material for an electrophotographic photoreceptor, an amplitude in a range of a period of 0.4 mm or more and 0.7 mm or less is 0.22 mm or less.

2. The base material for an electrophotographic photoreceptor according to claim 1, wherein the amplitude is 0.18 mm or less.

3. The base material for an electrophotographic photoreceptor according to claim 1, wherein in the spectrum, number of amplitude peaks included in a range of a period of 0.4 mm or more and 1.0 mm or less is two or more.

4. The base material for an electrophotographic photoreceptor according to claim 3, wherein the number of amplitude peaks is three.

5. The base material for an electrophotographic photoreceptor according to claim 4, wherein in the spectrum, a frequency component in a range of a period of 0.4 mm or more and 0.6 mm or less is 30% or more and 50% or less with respect to an entire frequency component in the range of the period of 0.4 mm or more and 1.0 mm or less.

6. The base material for an electrophotographic photoreceptor according to claim 5, wherein in the spectrum, the frequency component in the range of the period of 0.4 mm or more and 0.6 mm or less is 35% or more and 45% or less with respect to the entire frequency component in the range of the period of 0.4 mm or more and 1.0 mm or less.

7. An electrophotographic photoreceptor comprising:
the base material for an electrophotographic photoreceptor according to claim 1; and
a photosensitive layer provided on the base material for an electrophotographic photoreceptor.

8. The electrophotographic photoreceptor according to claim 7, wherein the amplitude of the base material for an electrophotographic photoreceptor is 0.18 mm or less.

9. The electrophotographic photoreceptor according to claim 7, wherein in the spectrum of the base material for an electrophotographic photoreceptor, number of amplitude peaks included in a range of a period of 0.4 mm or more and 1.0 mm or less is two or more.

10. The electrophotographic photoreceptor according to claim 9, wherein the number of amplitude peaks of the base material for an electrophotographic photoreceptor is three.

11. The electrophotographic photoreceptor according to claim 10, wherein in the spectrum of the base material for an electrophotographic photoreceptor, a frequency component in a range of a period of 0.4 mm or more and 0.6 mm or less is 30% or more and 50% or less with respect to an entire frequency component in the range of the period of 0.4 mm or more and 1.0 mm or less.

12. The electrophotographic photoreceptor according to claim 11, wherein in the spectrum of the base material for an electrophotographic photoreceptor, the frequency component in the range of the period of 0.4 mm or more and 0.6 mm or less is 35% or more and 45% or less with respect to the entire frequency component in the range of the period of 0.4 mm or more and 1.0 mm or less.

13. A process cartridge comprising the electrophotographic photoreceptor according to claim 7, the process cartridge being detachably attachable to an image forming apparatus.

14. An image forming apparatus comprising:
the electrophotographic photoreceptor according to claim 7;
a charging unit that charges a surface of the electrophotographic photoreceptor;
an electrostatic latent image forming unit that forms an electrostatic latent image on the charged surface of the electrophotographic photoreceptor;
a developing unit that forms a toner image by developing the electrostatic latent image formed on the surface of the electrophotographic photoreceptor with a developer containing a toner; and
a transfer unit that transfers the toner image onto a surface of a recording medium.
